(19) United States
(12) Patent Application Publication
(10) Pub. No.: US 2002/0122313 A1
(43) Pub. Date: Sep. 5, 2002

(54) Fiber optic arrangement for christmas light

(76) Inventor: Jack Chang, Taichung (TW)

Correspondence Address: Kuo-Hsiung Chiu, 13F. , No. 23, Jiun-Ho Street, Peitun District, Taichung, TW

(21) Appl. No.: 09/796,983

(22) Filed: Mar. 2, 2001

(51) Int. Cl. F21V 7/04

(52) U.S. Cl. 362/554; 362/565; 362/568; 362/581

(57) ABSTRACT

The present invention relates to a fiber optic arrangement for Christmas light having a socket mounted on the Christmas light bulb. A plurality of fiber optic elements are mounted on the socket, thereby increasing the decorating effect of the Christmas light. In addition, a socket is hollow-shaped inside thereof. One end thereof is provided with a mounting opening for receiving a Christmas light bulb while the other end thereof includes a plurality of connecting holes for receiving fiber optic bundles. The connecting holes communicate with the hollow part inside of the socket so that the fiber optic bundles receive the light source of the Christmas light bulb, thereby creating a radial lighting effect.

### BACKGROUND OF THE INVENTION

1. Field of the Invention

The present invention relates to a fiber optic arrangement for Christmas light, and more particularly to a fiber optic arrangement applicable to the conventional Christmas light bulbs in order to increase the lighting effect of the Christmas decorating light.

2. Description of the Prior Art

The conventional for Christmas light arrangement includes a long string of series-connected light bulbs. Whether the twinkling effect of the light bulbs creates a graceful and attractive atmosphere essentially depends on the amount of the arranged light bulbs and the arrangement design thereof. As shown in FIG. 4, the light bulb of the conventional Christmas lighting is strip-shape in single one type so that the lighting effect is a single lighting pattern. Therefore, the lighting effect is restricted. Besides, the light bulbs have to reach a certain amount for creating a required atmosphere, thereby increasing the cost loading and the arrangement inconvenience. In addition, the electricity is more consumed because more light bulbs are arranged, thereby causing the unnecessary waste of electric resources.

### SUMMARY OF THE INVENTION

It is a primary object of the present invention to eliminate the drawbacks associated with the prior art and to provide a fiber optic arrangement for Christmas light having the following effects:

1. To save the amount of the light bulbs and the electric cord: The fiber optic bundles are mounted on a light bulb so that the amount of the used bulbs can be reduced while the graceful lighting effect can also be reached. Since the amount of the light bulbs is reduced so that the electric cord in wiring the light bulbs is also reduced. Thus, the inconvenience of too much wiring is avoided.

2. To have a different lighting effect from that of the conventional one. The conventional Christmas light bulb can show the single lighting effect while the present invention can show the radial and cylindrical lighting effect by means of the arrangement of the fiber optic bundles. Moreover, the lighting effect can be changed with the twinkling frequency and lighting color of light bulbs, thereby creating a more attractive lighting effect.

3. An excellent suitability and easy assembly: The present invention is suitable for any Christmas light bulb on the market without additional design and manufacture of light bulbs. Meanwhile, the assembly in engaging way is very convenient and stable.

4. An excellent durability: The present invention is connected with the Christmas light bulb in an engaging way. Therefore, if the light bulbs are damaged or the wiring is malfunction, the whole string of light bulbs is discarded while the socket of the present invention can be used again.

### BRIEF DESCRIPTION OF THE DRAWINGS

The accomplishment of this and other objects of the invention will become apparent from the following description and its accompanying drawings of which:

FIG. 1 is a perspective exploded view of the present invention;

FIG. 2 is a sectional view of the present invention after assembly;

FIG. 3 is a schematic drawing of an application embodiment of the present invention; and

FIG. 4 is a perspective view of a conventional Christmas light.

### DETAILED DESCRIPTION OF THE PREFERRED EMBODIMENT

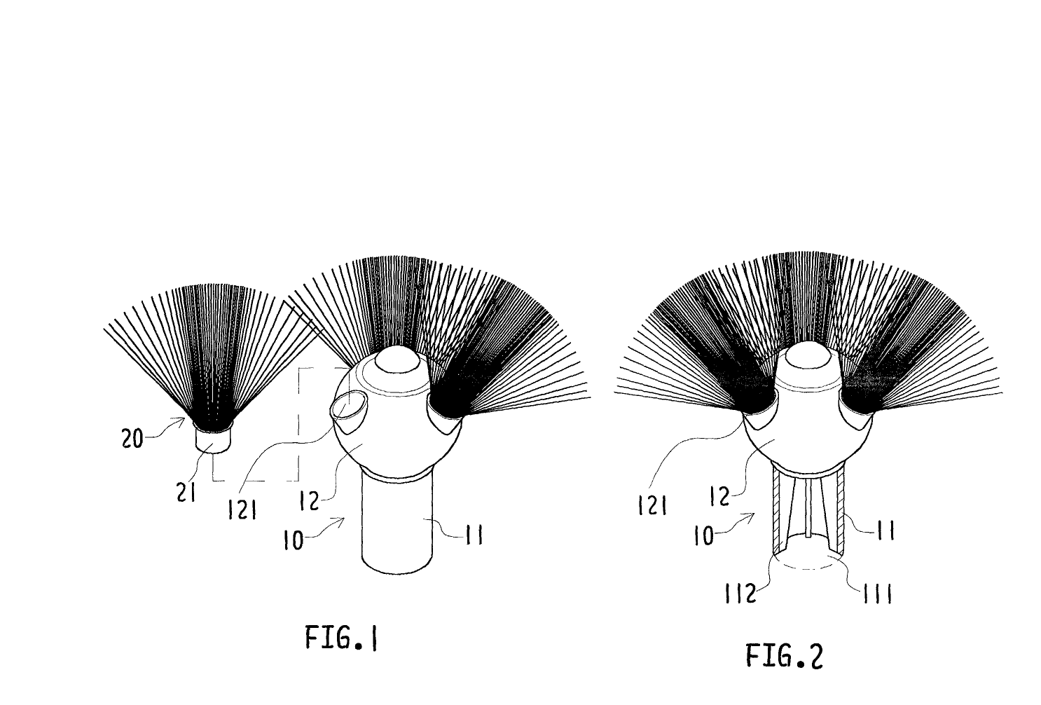

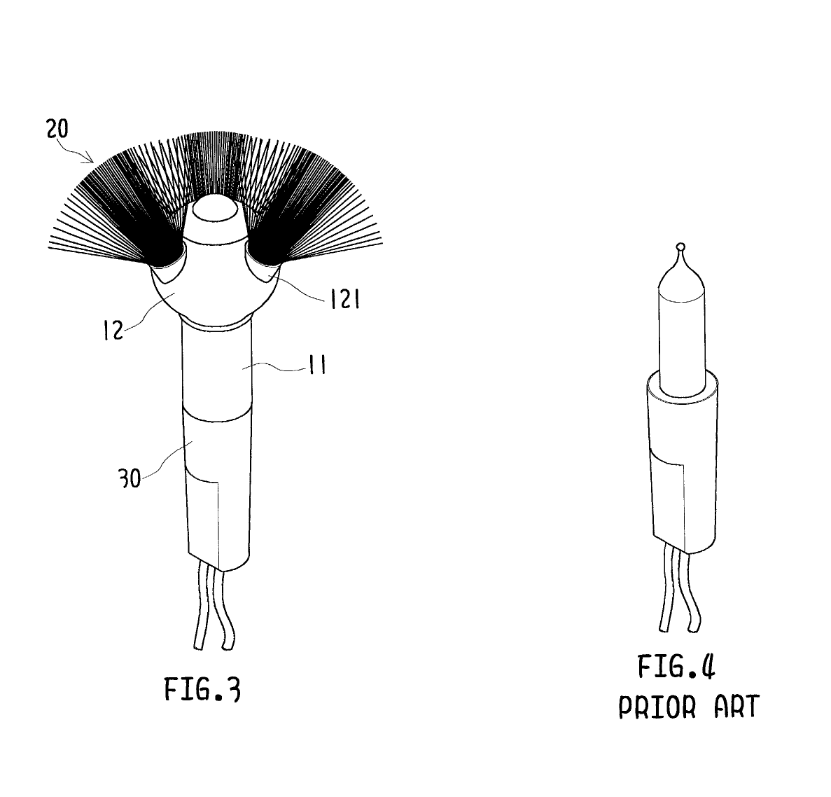

Referring to FIGS. 1 through 3, the fiber optic arrangement for Christmas light in accordance with the present invention includes a socket 10 mounted on a Christmas light bulb 30 and having a plurality of fiber optic bundles 20 which receive the light source of the Christmas light bulb 30 to increase the light effect scattered by the Christmas light bulb 30 and to reduce the amount of the light bulbs and the power loading.

The socket 10 is constructed as a hollow geometric body, and can be formed in a body or composed of several components. The mounting piece 11 includes a mounting opening 111 in which a plurality of locking ribs 112 are symmetrically arranged. The locking ribs 112 are made of plastic material and the Christmas light bulb 30 can be inserted thereinto. A holding element 12 opposite to the mounting piece 11 includes a plurality of connecting holes 121 which communicate with the hollow part inside the socket 10 and are used to receive the fiber optic bundles 20.

Each of the fiber optic bundles 20 includes a holding element 21 in which a plurality of fiber optic strings are collected. The fiber optic bundles 20 are inserted into the connecting holes 121 to receive the light source created by the Christmas light bulb 30 so that the exposed fiber optic bundles 20 produce a radial lighting effect.

Accordingly, the lighting effect of the Christmas decoration light can be improved by means of the fiber optic bundles 20. Meanwhile, the fiber optic bundles 20 are formed in a scattered type, thereby increasing the twinkling area of light. Moreover, a Christmas light bulb 30 is used for several fiber optic bundles 20 so that the amount of the Christmas light bulbs 30 can be reduced, thereby reducing the production cost and the power consumption.

Furthermore, the socket 10 of the present invention is made of heat-resistant material so that it won't have any bad result after use. Moreover, it is suitable for all-sized Christmas light bulbs on the market. As for the assembly, the attachment of the Christmas light bulb 30 to the socket 10 is more stable, convenient and suitable for more types. In addition, the locking ribs 112 inside the mounting opening 111 of the socket 10 can be tapered to firmly lock the Christmas light bulb 30.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A fiber optic arrangement for Christmas light comprising a socket being hollow-shaped inside thereof, one end thereof being provided with a mounting opening for receiving a Christmas light bulb while the other end thereof includes a plurality of connecting holes for receiving fiber optic bundles, said connecting holes communicating with the hollow part inside of said socket so that said fiber optic bundles receive the light source of said Christmas light bulb, thereby creating a radial lighting effect.

2. A fiber optic arrangement for Christmas light as claimed in claim 1, wherein a plurality of locking ribs symmetrically mounted on the inner wall of said mounting opening and made of plastic material, and said locking ribs can be tapered for receiving all types of Christmas light bulbs.
